(19) United States
(12) Patent Application Publication
(10) Pub. No.: US 2025/0133295 A1
(43) Pub. Date: Apr. 24, 2025

(54) IMAGE PROCESSING SYSTEM

(71) Applicant: CANON KABUSHIKI KAISHA, Tokyo (JP)

(72) Inventors: Keisuke KOBAYASHI, Tokyo (JP); Yuta URANO, Tokyo (JP)

(21) Appl. No.: 18/908,891

(22) Filed: Oct. 8, 2024

(30) Foreign Application Priority Data
Oct. 18, 2023 (JP) 2023-179386

(51) Int. Cl. H04N 23/698; G06T 7/70; G06V 10/14; G06V 20/54

(52) U.S. Cl. CPC H04N 23/698; G06T 7/70; G06V 10/14; G06V 20/54; G06T 2207/30232; G06T 2207/30236; G06V 2201/07; G06V 2201/08

(57) ABSTRACT

An image processing system includes an imaging unit disposed near an intersection and configured to capture a movable unit, a sensor surface of the imaging unit having a high-resolution area close to a center of the sensor surface and less than a predetermined half angle of view from the center of the sensor surface, and a low-resolution area close to a periphery of the sensor surface and equal to or greater than the predetermined half angle of view, and a detector configured to detect a position of the movable unit in an image generated by the imaging unit disposed so that a predetermined area near the intersection can be captured as the high-resolution area.

### BACKGROUND

### Technical Field

The present disclosure relates to an image processing system.

### Description of Related Art

A system has conventionally been proposed that includes an installation type camera, such as a surveillance camera, configured to capture images of movable units such as vehicles and people, and detects their positions in the images to generate positions on a map plane and three-dimensional spatial information (see Japanese Patent Laid-Open No. 2018-046501).

A certain level of resolution is demanded to accurately detect an object from an image. Therefore, to accurately detect an object distant from the camera, it is necessary to capture the distant object with high resolution using a camera with a narrow angle of field. However, the camera with a narrow angle of field cannot capture a wide range, and a detectible range is narrow. On the other hand, a wide-angle camera such as a fisheye lens has a low resolution of an object in a distant area is low, and the detection accuracy is reduced.

### SUMMARY

An image processing system according to one aspect of the disclosure includes an imaging unit disposed near an intersection and configured to capture a movable unit, a sensor surface of the imaging unit having a high-resolution area close to a center of the sensor surface and less than a predetermined half angle of view from the center of the sensor surface, and a low-resolution area close to a periphery of the sensor surface and equal to or greater than the predetermined half angle of view, and a detector configured to detect a position of the movable unit in an image generated by the imaging unit disposed so that a predetermined area near the intersection can be captured as the high-resolution area.

Further features of various embodiments of the disclosure will become apparent from the following description of embodiments with reference to the attached drawings.

### BRIEF DESCRIPTION OF THE DRAWINGS

FIG. 1 is a schematic diagram of an intersection surveillance system, which is an example of an image processing system according to one embodiment of the present disclosure, viewed from a horizontal direction of a road surface.

FIG. 2 is a block diagram of an observation apparatus.

FIG. 3 is a flowchart illustrating processing executed by an information processing unit.

FIG. 4A illustrates an image height at each half angle of view on a light receiving surface of an image sensor in contour lines, and FIG. 4B illustrates a relationship between a half angle of view and an image height in a first quadrant of FIG. 4A.

FIG. 5 is a graph illustrating an example of equidistant projection and a resolution characteristic of an optical system.

FIGS. 6A to 6C illustrate captured images for each optical system.

FIG. 7 explains the arrangement of the observation apparatus.

FIG. 8 explains the arrangement of the observation apparatus.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

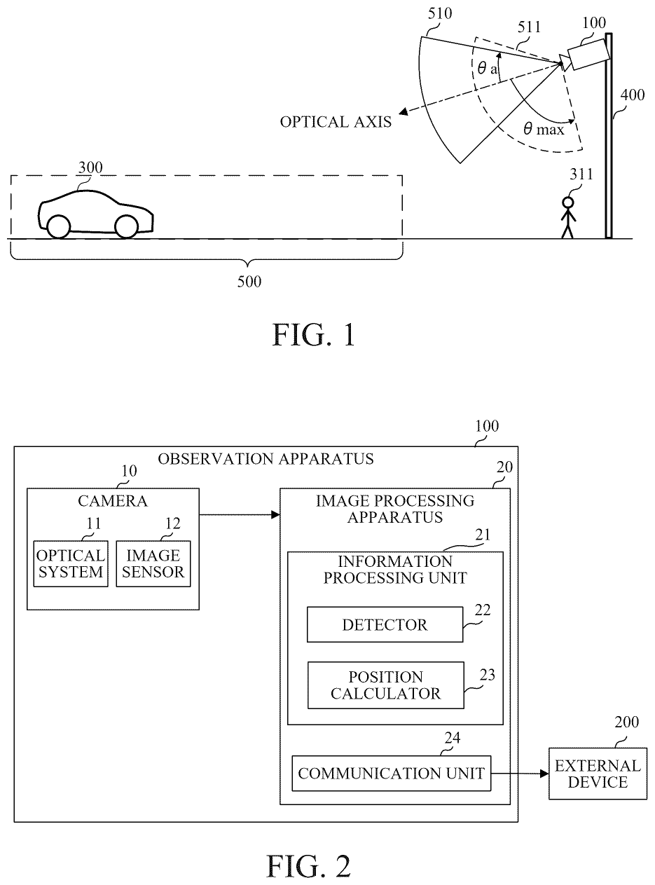

FIG. 1 is a schematic diagram of an intersection surveillance system, which is an example of an image processing system according to one embodiment of the present disclosure, viewed from a horizontal direction of a road surface. In the intersection surveillance system, an observation apparatus 100 is disposed near an intersection and functions as a surveillance camera. The observation apparatus 100 includes a housing mounted with a camera, an information processing unit, and a communication unit, and is fixed and installed on a support 400, which is a pole-shaped facility such as a utility pole near the intersection. The observation apparatus 100 may be installed on a structure such as a building.

The observation apparatus 100 is disposed so as to capture a movable unit such as a vehicle 300 or a pedestrian (not illustrated) moving (passing) within an area to be detected (target area) 500, and detects the position of the movable unit in the captured image. The camera 10 (not illustrated) built into the observation apparatus 100 generates an image including a first area 510 (high-resolution area) from the optical axis to a half angle of view θa, and a second area 511 (low-resolution area) from the optical axis to a maximum half angle of view θₘₐₓ (>θa). At this time, the position of the movable unit can be detected with high accuracy by installing the observation apparatus 100 so that the target area 500 is included in the high-resolution area (so that a specific area can be imaged as a high-resolution area). In the following description, an area in which object detection is sought with higher accuracy is called an attention area. A pedestrian 311 near the observation apparatus 100 can also be included in the imaging range, and the situation can be grasped with a wide angle of view. The position information of the movable unit is generated by calculating the position of the movable unit on the map plane from the coordinates on the image. The position information is used, for example, to grasp the road situation and to notify vehicles and pedestrians of the approach of another vehicle or intrusion into an intersection. Thereby, the danger is notified and safety is secured.

FIG. 2 is a block diagram of the observation apparatus 100. The observation apparatus 100 includes a housing with a camera (imaging unit) 10 and an image processing unit 20, and functions as a surveillance camera to capture the movable unit. The camera 10 and the image processing unit 20 do not have to be in the same housing, and only image information may be transmitted from the camera 10 to the image processing unit 20 in a separate housing by wired or wireless communication.

The camera 10 includes an image sensor 12 configured to capture an optical image, and an optical system 11 configured to form the optical image on the light receiving surface (imaging surface) of the image sensor 12, and acquires the surrounding situation as image data. The optical system 11 has an optical characteristic of forming a high-resolution optical image in a narrow angle of view area around the optical axis and a low-resolution optical image in a peripheral angle of view area distant from the optical axis. The image sensor 12 is, for example, a CMOS image sensor or a CCD image sensor, and performs photoelectric conversion for the optical image to output imaging data. The image sensor 12 has, for example, RGB color filters arranged for each pixel in a Bayer array, and can acquire a color image by performing demosaic processing.

The image processing unit 20 is a computer that includes an information processing unit 21, a communication unit 24, a memory (not illustrated), and various interfaces (not illustrated) for power input and output, and includes various hardware. The image processing unit 20 is also connected to the camera 10, analyzes image data acquired from the camera 10 to generate various information, and outputs the information to an external device 200 via the communication unit 24.

The information processing unit 21 performs various controls of the entire observation apparatus 100 by executing computer programs stored in memory. In this embodiment, the information processing unit 21 is a CPU, and the image processing unit 20 is described as a computer having a RAM and ROM, but the present disclosure is not limited to this example. The information processing unit 21 may be, for example, a System On Chip (SOC), a Field Programmable Gate Array (FPGA), an ASIC, a DSP, and a Graphics Processing Unit (GPU).

The information processing unit 21 also performs signal processing for the image acquired from the camera 10. More specifically, image data input from the camera 10 is de-Bayer-processed according to the Bayer array, and converted into image data in an RGB raster format. Various image processing and image adjustments are performed, such as white balance adjustment, gain/offset controls, gamma processing, color matrix processing, lossless compression processing, and lens distortion correction processing.

The information processing unit 21 includes a detector 22 and a position calculator (acquiring unit) 23. The detector 22 performs image recognition based on the image captured by the camera 10, and detects the object position on the image. The position calculator 23 performs coordinate conversion (projection transformation) processing from camera coordinates (plane) to world coordinates (plane) using the object position detected on the image by the detector 22.

The memory is an information memory such as a ROM, and stores information for controlling the entire observation apparatus 100. The memory may be a removable recording medium such as a hard disk drive or an SD card. The memory stores various information such as parameters for controlling the camera 10 and the image processing unit 20, and coordinate conversion tables for image processing and deformation/coordinate conversion processing. The memory may record image data generated by the image processing unit 20.

The communication unit 24 is a network interface for outputting information processed by the image processing unit 20 to the external device 200. The communication unit 24 is connected to the external device 200 by wire or wirelessly and performs bidirectional communication.

The external device 200 acquires information output from the observation apparatus 100, processes and analyzes the acquired information, and displays it on a display or the like to notify the user of the information. The external device 200 may continue to record information as log data without having a display function, or may transmit information to another terminal. The external device 200 may also be mounted on a movable unit such as a vehicle.

In this embodiment, the information processing unit 21 is included in the housing of the observation apparatus 100, but it may not be included in the housing of the observation apparatus 100. For example, the image acquired by the observation apparatus 100 may be directly transmitted to the external device 200, and similar processing may be performed using an information processing unit in the external device 200.

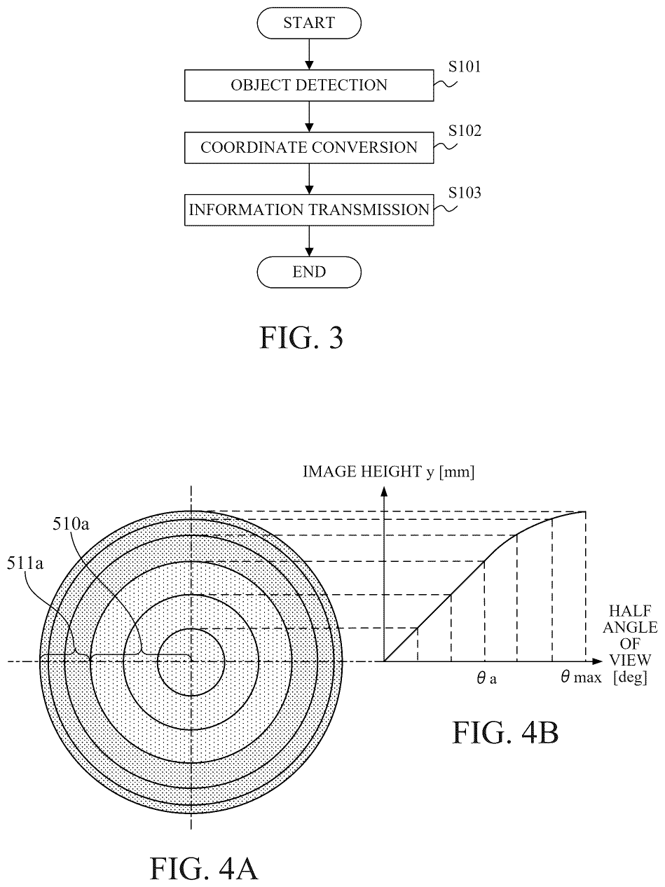

FIG. 3 is a flowchart illustrating the processing executed by the information processing unit 21. The information processing unit 21, which is a CPU as a computer, executes a computer program stored in a memory to perform the operation of each step of the flowchart in FIG. 3.

The flow in FIG. 3 is started by acquiring an image captured by the camera 10. The camera 10 periodically acquires images, for example, at 60 frames per second, and the flow in FIG. 3 is executed for each frame.

In step S101, the information processing unit 21 (detector 22) detects an object (observation target) such as a vehicle from the image acquired from the camera 10 by image recognition. That is, the object position on the image is detected based on the image. A model that has been trained by deep learning can be used as a method for detecting an object. A bounding box may be assigned to the detected object, or the detected object may be extracted in pixel value units as semantic area division. Template matching or the like may be used as a method for detecting an object. In a method for detecting an object from image information, the detection accuracy generally increases when the object is captured clearly with high resolution. Therefore, in the high-resolution area generated by the camera 10, object detection can be performed with higher accuracy than in other areas.

In step S102, the information processing unit 21 (position calculator 23) performs coordinate transformation (projection transformation) of the object position in the image from the camera coordinates (plane) to the world coordinates (plane). That is, transformation is performed from the object position on the image to the object position in the world coordinates. The object position on the image is set to the camera coordinates (plane), and the world coordinates (plane) are the same as the road surface (plane) (although it does not coincide in a wide area, it is locally the same). The projection transformation matrix for the coordinate transformation may be generated from the position of the observation apparatus 100 or the three-dimensional information on the object to be imaged. A projection transformation matrix for the coordinate transformation may be generated by linking an orthoimage including map information such as latitude and longitude with corresponding points in an image captured by the camera 10. Converting the detected object detected in step S101 from the camera coordinates (plane) to the world coordinates (plane) can provide the position of the detected object in the world coordinates (plane). At this time, for example, a position as a midpoint of the lower side of the bounding box detected in step S101 can be set as the representative point. Thereby, the position of the observation target can be represented by a single point in the world coordinates (plane) in step S102. In other words, the target area 500 can be rephrased as an area in which the position in the world coordinates (plane) can be obtained. The method of determining the position of the observation target in this embodiment is merely illustrative, and the present disclosure is not limited to this example.

In step S103, the information processing unit 21 transmits information such as a predicted position of the observation target to the external device 200 via the communication unit 24.

Referring now to FIGS. 4A and 4B, a description will be given of an optical characteristic of the optical system 11. FIG. 4A illustrates an image height y at each half angle of view on the light receiving surface of the image sensor 12 in the form of contour lines, and FIG. 4B illustrates a relationship between a half angle of view θ and the image height y in the first quadrant of FIG. 4A (the projection characteristic of the optical system 11).

As illustrated in FIG. 4B, the optical system 11 is configured so that the projection characteristic y(θ) differs at angles of view less than (or equal to or less than) the certain half angle of view θa and angles of view equal to or greater than the half angle of view θa (θa is an absolute value). Thus, in a case where an increase amount in image height y per unit of half angle of view θ is defined as resolution, the optical system 11 is configured so that the resolution differs according to an angle of view (the area on the light receiving surface of the image sensor 12). The local resolution can be expressed as a differential value dy(θ)/dθ of the projection characteristic y(θ) at the half angle of view θ. For example, as the slope of the projection characteristic y(θ) in FIG. 4B increases, the resolution becomes higher. FIG. 4A illustrates that as an interval between the contour lines of image height y increases at each half angle of view, the resolution becomes higher.

In this embodiment, the optical system 11 has a projection characteristic such that an increase rate of the image height y (the slope of the projection characteristic y(θ) in FIG. 4B) increases in the central area near the optical axis, and the increase rate of the image height y decreases as the angle of view increases in the peripheral area outside the central area.

In FIG. 4A, a first area 510a (high-resolution area) including the center corresponds to an angle of view less than the half angle of view θa, and a second area 511a (low-resolution area) outside the first area 510a corresponds to an angle of view equal to or greater than the half angle of view θa. An angle of view less than the half angle of view θa corresponds to the first area 510 in FIG. 1, and a combined angle of view of the angle less than the half angle of view θa and the angle of view equal to or greater than the half angle of view θa corresponds to the second area 511 in FIG. 1. As described above, the first area 510a is an area with a relatively high resolution, and the second area 511a is an area with a relatively low resolution. The first area 510a is a low-distortion area with a relatively small distortion amount, and the second area 511a is a high-distortion area with a relatively large distortion amount. Therefore, in this embodiment, the first area 510a may be called a high-resolution area or a low-distortion area, and the second area 511a may be called a low-resolution area or a high-distortion area.

The characteristic in FIG. 4 is merely illustrative, and the present disclosure is not limited to this example. For example, the low-resolution area and the high-resolution area of the optical system 11 may not be concentrically configured, and each area may have a distorted shape. The center of gravity of the low-resolution area and the center of gravity of the high-resolution area do not have to coincide. The center of gravity of the low-resolution area and the center of gravity of the high-resolution area may be shifted from the center of the light receiving surface of the image sensor 12.

In the optical system 11 according to this embodiment, the high-resolution area may be formed near the optical axis, and the low-resolution area may be formed on the peripheral side near the optical axis.

The optical system 11 is configured so that the projection characteristic y(θ) in the first area 510a is greater than f×θ, where f is a focal length of the optical system 11. The projection characteristic y(θ) in the first area 510a is set to be different from the projection characteristic in the second area 511a.

A ratio θa/θmax of the half angle of view θa to the maximum half angle of view θmax of the optical system 11 may be equal to or greater than a predetermined lower limit, and the predetermined lower limit is, for example, 0.15 to 0.16. The ratio θa/θmax may be equal to or less than a predetermined upper limit, and the predetermined upper limit is, for example, 0.25 to 0.35. For example, in a case where the half angle of view θmax is 90°, the predetermined lower limit is 0.15, and the predetermined upper limit is 0.35, the half angle of view θa may be determined in a range of 13.5 to 31.5°. This is merely illustrative, and the present disclosure is not limited to this example.

The optical system 11 may be configured such that the projection characteristic y(θ) satisfies the following inequality (1):

$$1 < \frac{2 f \times sin {θ}_{max}}{y ( {θ}_{max} )} \leq A \qquad ( 1 )$$

Here, f is a focal length of the optical system 11 as described above, and A is a predetermined constant. By setting the lower limit to 1, the central resolution can be higher than that of a fisheye lens of the orthogonal projection type (y=f×sin θ) having the same maximum imaging height. Setting the upper limit to the predetermined constant A can provide an angle of view equivalent to that of a fisheye lens while maintaining good optical performance. The predetermined constant A can be determined based on the balance of the resolution of the high-resolution area and the resolution of the low-resolution area, and may be 1.4 to 1.9. This is merely illustrative, and the present disclosure is not limited to this example.

By configuring the optical system 11 as described above, a high resolution can be obtained in the first area 510a, while an increase amount of the image height y per unit half angle of view θ is reduced in the second area 511a and a wider angle of view can be captured. Thus, a high resolution can be captured in the high-resolution area while an imaging range with a wide angle of view equivalent to that of a fisheye lens can be maintained.

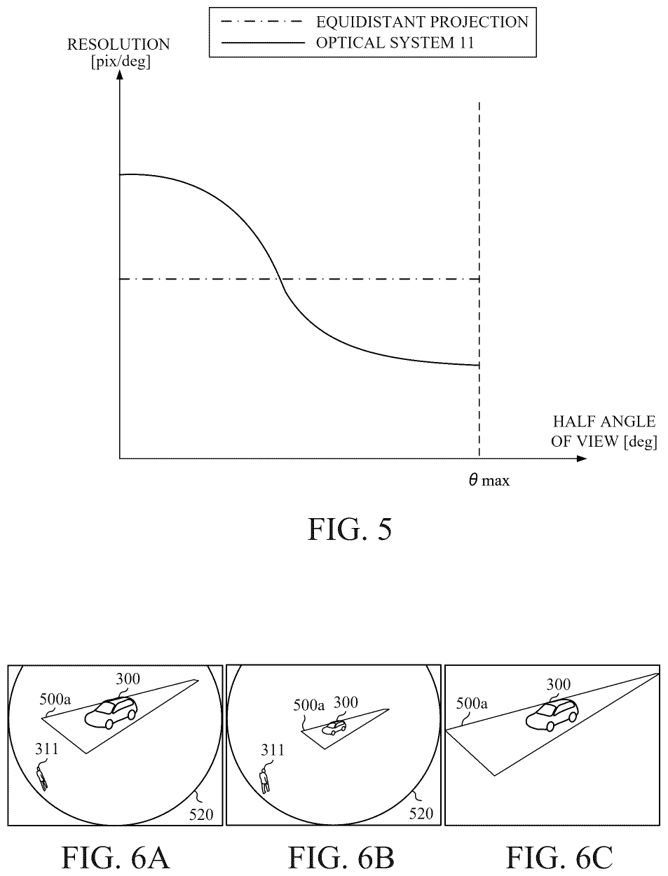

FIG. 5 is a graph illustrating an example of equidistant projection and the resolution characteristic of optical system 11. A horizontal axis represents a half angle of view θ, and a vertical axis represents resolution, which is the number of pixels per unit angle of view. In the equidistant projection, the resolution is constant at any of half-angle-of-view positions, but optical system 11 has such a characteristic that the resolution is higher at a smaller half-angle-of-view position.

The optical system 11 with the above characteristic can provide, for example, a high-resolution image in the high-resolution area while capturing a wide angle of view equivalent to that of a fisheye lens with a half angle of view θmax. In the optical system 11, an area near the optical axis is the high-resolution area, and the optical system 11 has a characteristic similar to the central projection method (y=f×tan θ), which is the projection characteristic of an optical system for normal imaging. Therefore, optical distortion is small and high-definition image can be displayed. Properly placing the high-resolution area in the target area can provide highly accurate detection and enables a wide angle of view to be imaged. In the following description, an area in the target area where object detection with high accuracy is desired will be called an attention area (within the target area).

FIGS. 6A, 6B, and 6C illustrate captured images for each optical system. FIG. 6A is an image generated by the optical system 11 according to this embodiment, in which the vehicle 300 inside the target area 500 and the pedestrian 311 outside the target area 500 correspond to those of FIG. 1, and an area 500a is the road surface part of the target area 500. FIG. 6B is an image generated by an optical system with an equidistant projection characteristic (y=f×θ). Although the projection characteristics are different between FIGS. 6A and 6B, an imaging angle of view (imaging range) corresponding to the half angle of view θmax is the same. FIG. 6C is an image generated by an optical system with a central projection characteristic (y=f×tan θ). The imaging angle of view in FIG. 6C is changed so that the size of the vehicle 300 on the image illustrated in FIG. 6A is approximately the same. Here, an effective image circle 520 in FIGS. 6A and 6B represents an imaging range of the optical system 11 on the light receiving surface, and no image is generated (a black image is acquired) outside the range of the effective image circle 520. The half angle of view θmax of the optical system 11 corresponds to the range of the effective image circle 520, and an image is generated only inside the half angle of view θmax.

In FIGS. 6A and 6B, the center of the image sensor and the center of the optical axis are shifted, and the upper part of the effective image circle 520 is outside the range of the image sensor and an image is partially missing. It is unnecessary to shift the optical axis, but for example, by shifting the optical axis until the bottom of the effective image circle 520 is on the light receiving surface of the image sensor, the imaging range in the downward direction of the image (the road surface direction in FIG. 1) can be expanded. Thereby, the imaging range can be changed according to the use case. In an intersection surveillance system, the observation apparatus 100 may be installed at a position high above the road surface so as to capture the distant road surface, and to secure a wide angle of view in the directly downward direction of the observation apparatus 100. In this case, shifting the optical axis as described above can effectively image a distant area and an area in the directly downward direction.

The case of the equidistant projection method in FIG. 6B can secure a wide angle of view, so that even pedestrians 311 close to the camera can be imaged, but the resolution within the area 500a is low (small on the image), and the detection accuracy is reduced.

The case of the central projection method of FIG. 6C can secure a high resolution of the area 500a, but cannot secure a wide angle of view. Therefore, the pedestrian 311 is not captured, and many blind spots occur near the camera. It is conceivable to zoom an attention area and capture it at a high resolution using a zoom lens, but it is impossible to capture a wide area nearby at the same time when the attention area is captured at a high resolution.

As illustrated in FIG. 6A, the optical system 11 according to this embodiment generates an image having a high-resolution area near the optical axis and a low-resolution area around it, as described above, and thus can capture a wide angle of view while maintaining the high resolution of the area 500a. Thereby, the intersection surveillance system according to this embodiment can grasp the situation near the camera 10 at a wide angle of view while maintaining the high detection accuracy of the target area.

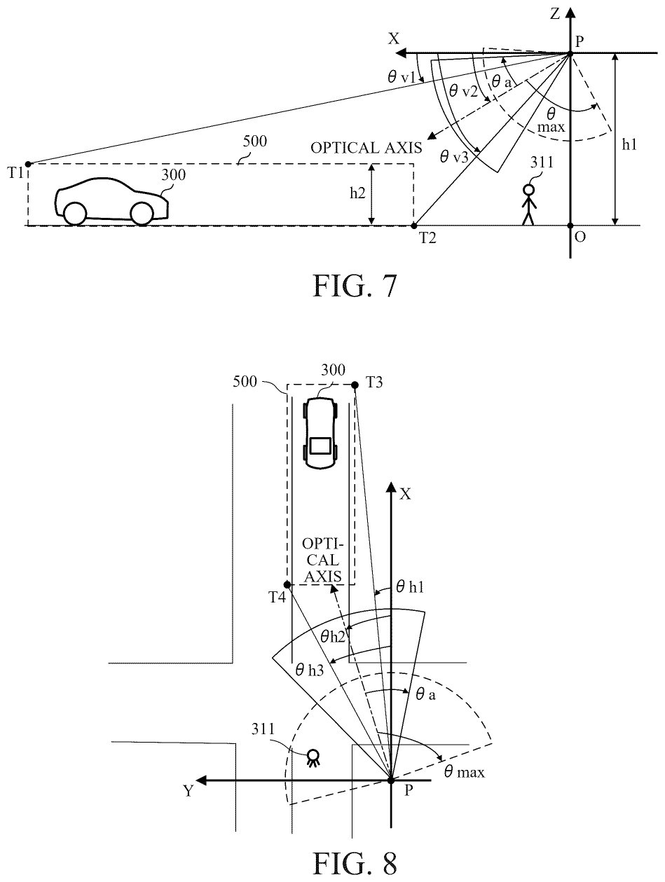

FIG. 7 explains the arrangement of the observation apparatus 100, and illustrates a schematic diagram of the intersection surveillance system viewed from the horizontal direction to the road surface. In FIG. 7, the observation apparatus 100 (not illustrated) is disposed at a point P, which is at a height h1 from a point O on the road surface plane. More specifically, the camera 10 is disposed so that its optical center is located at the point P. The Z axis is an axis perpendicular to the road surface plane, and the X axis is an axis perpendicular to the Z axis and passes through the point P. That is, FIG. 7 is a schematic diagram on the XZ plane.

In this case, the target area 500 can be expressed as a rectangle on the XZ plane with a height h2. Straight lines PT1 and PT2 are straight lines that pass through point P and circumscribe the target area 500. The height h2 may vary according to an approximate size of the detection target, and may be considered to be 0 by ignoring the height direction. In this case, the target area 500 can be considered as a plane on the road surface.

Here, θv1 is an angle between the line PT1 and the X-axis passing through point P, θV2 is an angle between the optical axis of the camera 10 and the X-axis passing through point P, and θV3 is an angle between the line PT2 and the X-axis passing through point P.

In this case, the observation apparatus 100 may be disposed so as to satisfy θv1≤θV2≤θV3. In addition, the observation apparatus 100 is disposed so as to satisfy at least one of θV2-θa≤θv1 and θV3≤θV2+θa.

FIG. 8 explains the arrangement of the observation apparatus 100, and illustrates a schematic diagram (plane view) of an intersection surveillance system when viewed from the road surface. In FIG. 8, the observation apparatus 100 is positioned near the intersection, and a situation is illustrated in which the vehicle 300 within the target area 500 is traveling straight toward the intersection.

In FIG. 8, the observation apparatus 100 (not illustrated) is positioned at the point P. More specifically, it is positioned so that the optical center of the camera 10 is located at the point P. Here, the upward direction in FIG. 8 is the X-axis direction, and the left direction in FIG. 8, which is perpendicular to the X-axis, is the Y-axis direction. That is, FIG. 8 is a schematic diagram on the XY plane (on the map plane).

At this time, the target area 500 can be expressed as a rectangle on the XY plane. The target area 500 does not necessarily have to be rectangular, and may be an area surrounded by curved lines. The target area 500 may be a wide area extending to infinity in the X-axis direction. Straight lines PT3 and PT4 are straight lines passing through point P and circumscribing the target area 500.

Here, θh1 is an angle between the straight line PT3 and the X-axis passing through point P, θh2 is an angle between the optical axis of the camera 10 and the X-axis passing through point P, and θh3 is an angle between the straight line PT4 and the X-axis passing through point P. At this time, the observation apparatus 100 may be disposed so as to satisfy θh1≤θh2≤θh3. In addition, the observation apparatus 100 is disposed so as to satisfy at least one of θh2-θa≤θh1 and θh3≤θh2+θa.

As illustrated in FIGS. 7 and 8, by placing the observation apparatus 100 so that the target area 500 is included within the range of half angle of view θa from the optical axis of the camera 10, the target area 500 can be imaged using the high-resolution area of the camera 10, and an object can be detected with high accuracy. By imaging with a wide angle of view up to the half angle of view θmax, the situation near the observation apparatus 100 can be grasped. The entire target area 500 does not necessarily have to be included in the high-resolution area. For example, the observation apparatus 100 may be disposed so that a part of the target area 500 is included in the high-resolution area. Even in this case, an object can be detected with high accuracy in the high-resolution area, and the object detection can be performed using the low-resolution area.

This embodiment has discussed the intersection surveillance system as an image processing system, but the present disclosure is not limited to this example. The image processing system according to the present disclosure may be an installation type movable-unit surveillance system configured to capture a movable unit and uses it for object detection. For example, the movable unit to be imaged is not limited to a vehicle or a person, but may be a train, a ship, an airplane, a robot, a drone, an animal, or the like. The situation to be imaged does not have to be an intersection, and may be a straight or curved road, or may not be a roadway. It may be an indoor corridor, a warehouse, the sea, an airway, or other space. Even in that case, placing the camera 10 so that the high-resolution area of the camera 10 overlaps the attention area (area to be detected) can provide imaging with a wide angle of view while maintaining the detection accuracy of the target area.

In this embodiment, the optical system 11 has a special projection characteristic, and thereby generates an image having a high-resolution area and a low-resolution area, but the present disclosure is not limited to this example. For example, a similar effect can be obtained by generating a high-resolution area by making variable the pixel density of the image sensor.

In this embodiment, the position calculator 23 obtains an object position in a different coordinate system from an object position on a detected image, but may not obtain the object position in the different coordinate system. Obtaining the object position is one of the effective application examples when the object is detected with high accuracy. The object detection result may be transmitted as it is to an external device, or the detection result may be analyzed and used for another purpose. Even in this case, the object position on the image can be detected with high accuracy by using the high-resolution area of the camera 10 for object detection.

In this embodiment, the target area 500 and the attention area are the same (are not distinguished), but the target area for object detection by the observation apparatus 100 and the attention area do not have to be the same. As described above, the attention area is an area to be detected with higher accuracy in detecting a movable unit. In other words, it is an important detection area for an image processing system. For example, a system is conceivable in which the entire area of a captured image is a target area and the detection result is used. Even in this case, placing the attention area so that it is included in the high-resolution area of the camera 10 can provide highly accurate object detection and an image with a wide angle of view.

A relationship between the arrangement of the observation apparatus 100 and the attention area will be described below. For example, the movable unit often travels along a fixed route. In other words, the observation apparatus 100 may be arranged by considering a (predicted) route of a movable unit as the attention area. For example, the attention area may be on a roadway on which a vehicle travels, a pedestrian flow line such as a corridor, a flight path of an airplane, or a path of a robot in a warehouse.

Even if the attention area is located on the same route, the pixel size of a moving object distant from the camera 10 on a captured image is small, so the detection accuracy is reduced. Therefore, setting a distant area on the route of the moving object as the attention area so that the attention area is included in the high-resolution area of the camera 10 can provide an image with a wide angle of view and highly accurate object detection. For example, as illustrated in FIG. 8, in a case where the observation apparatus 100 is disposed near an intersection and an area on a route (road) along the X-axis is captured, a distant area on the route in the image captured by the camera 10, or a position at infinity on the route in the image (the vanishing point on the route), may be included in the high-resolution area. Thereby, a distant moving object can be detected with high accuracy.

While the disclosure has described example embodiments, it is to be understood that some embodiments are not limited to the disclosed embodiments. The scope of the following claims is to be accorded the broadest interpretation so as to encompass all such modifications and equivalent structures and functions.

This embodiment can provide an image processing system that can provide detection with high accuracy by imaging a wide range and acquiring an attention area at high resolution.

This application claims priority to Japanese Patent Application No. 2023-179386, which was filed on Oct. 18, 2023, and which is hereby incorporated by reference herein in its entirety.

What is claimed is:

1. An image processing system comprising:
an imaging unit disposed near an intersection and configured to capture a movable unit, a sensor surface of the imaging unit having a high-resolution area close to a center of the sensor surface and less than a predetermined half angle of view from the center of the sensor surface, and a low-resolution area close to a periphery of the sensor surface and equal to or greater than the predetermined half angle of view; and
a detector configured to detect a position of the movable unit in an image generated by the imaging unit disposed so that a predetermined area near the intersection can be captured as the high-resolution area.

2. The image processing system according to claim 1, wherein the imaging unit includes an optical system configured to form an optical image, and to generate the image by capturing the optical image, and
wherein the optical image includes a high-resolution area corresponding to an angle of view less than the predetermined angle of view, and a low-resolution area corresponding to an angle of view greater than the predetermined angle of view and having resolution lower than that of the high-resolution area of the optical image.

3. The image processing system according to claim 2, wherein a projection characteristic expressing a relationship between a half angle of view of the optical system in the high-resolution area of the optical image and an image height on an image plane is set so that the image height for each half angle of view is larger than a product of a focal length of the optical system and the half angle of view, and the projection characteristic of the high-resolution area in the optical image is different from the projection characteristic of the low-resolution area in the optical image.

4. The image processing system according to claim 2, wherein the following inequality is satisfied:
$$1 < \frac{2 f \times sin {θ}_{max}}{y ( {θ}_{max} )} \leq A \qquad ( 1 )$$
where θ is a half angle of view of the optical system, y(θ) is a projection characteristic expressing a relationship between the half angle of view and an image height on an image plane, θmax is a maximum half angle of view of the optical system, f is a focal length of the optical system, and A is a predetermined constant.

5. The image processing system according to claim 1, wherein the imaging unit includes an optical system configured to form an optical image, and an image sensor configured to generate the image by capturing the optical image, and
wherein the optical system and the image sensor are disposed so that an optical axis of the optical system and the center of the sensor surface are shifted.

6. The image processing system according to claim 1, wherein the imaging unit is disposed so that at least a part of an area detectable by the detector is included in the high-resolution area.

7. The image processing system according to claim 6, wherein the at least part of the area detectable by the detector is a part on a route of the movable unit.

8. The image processing system according to claim 6, wherein the at least part of the area detectable by the detector is an area located on a route of the movable unit and more distant from the imaging unit.

9. The image processing system according to claim 1, further comprising an acquiring unit configured to acquire information using the position of the movable unit.

10. The image processing system according to claim 9, wherein the acquiring unit acquires position information of the movable unit in another coordinate system using the position of the movable unit.

11. The image processing system according to claim 1, wherein the image processing system is a movable-unit surveillance system.
